(19) United States
(12) Patent Application Publication
(10) Pub. No.: US 2026/0324558 A1
(43) Pub. Date: Oct. 22, 2026

(54) SPINDLE APPLICATOR PAD FOR A COTTON HARVESTING WORK VEHICLE

(71) Applicant: Deere & Company, Moline, IL (US)

(72) Inventors: Adam R. Eaker, Ankeny, IA (US); Brandon C. Carlson, Ankeny, IA (US); Bing Hui Dong, Ankeny, IA (US)

(21) Appl. No.: 19/356,862

(22) Filed: Oct. 13, 2025

Related U.S. Application Data
(60) Provisional application No. 63/790,489, filed on Apr. 17, 2025.

(51) Int. Cl. A01D 75/00; A01D 46/16

(52) U.S. Cl. CPC A01D 75/00; A01D 46/16

(57) ABSTRACT

An applicator pad for a cotton harvesting spindle is disclosed. The applicator pad comprises a pad body with a leading side and a leading end defining a leading corner at which the cotton harvesting spindle first encounters the pad body during operation. The pad body includes an output face with contact features projecting away from the output face and an input face opposite the output face. The input face defines a fluid channel including an oblique channel segment extending from the central region to proximate the leading corner, a lateral channel segment extending from proximate the leading corner along the leading end, and a longitudinal channel segment extending from proximate the leading corner along the leading side. The fluid channel defines through openings within the lateral channel segment and the longitudinal channel segment that are configured to direct the fluid from the input side to the output side.

### CROSS-REFERENCE TO RELATED APPLICATION(S)

This application claims the benefit of U.S. provisional application Ser. No. 63/790,489, filed Apr. 17, 2025, which is incorporated herein in its entirety.

### STATEMENT OF FEDERALLY SPONSORED RESEARCH OR DEVELOPMENT

Not applicable.

### FIELD OF THE DISCLOSURE

This disclosure generally relates to an applicator pad for cleaning spindles in a cotton harvesting work vehicle.

### BACKGROUND OF THE DISCLOSURE

Cotton harvesting work vehicles include a cotton harvesting system and a moisture system. The cotton harvesting system includes spindles and doffers. The spindles rotate and separate the cotton from the plant, and the doffers strip the cotton off the spindles. Debris from the cotton plants (e.g., cotton, cotton sap, and/or other plant debris) may remain on the spindles after the doffer removes the cotton. As such, the cotton related debris may stick to the spindles and eventually build up on the spindles. To mitigate the build-up of debris, the spindles pass through the moisture system to lubricate and clean the spindles to remove and help prevent the debris from sticking to the spindles. Specifically, an applicator pad may lubricate and scrub the spindle to remove cotton debris.

SUMMARY OF THE DISCLOSURE

In one implementation, an applicator pad for a cotton harvesting spindle is disclosed. The applicator pad includes a pad body with a leading side and a leading end defining a leading corner at which the cotton harvesting spindle first encounters the pad body during operation. The pad body having an output face with one or more contact features projecting away from the output face and an input face opposite the output face. The input face having a recess defining a fluid channel of the pad body. The fluid channel configured to direct a fluid from a central region of the pad body to proximate the leading corner of the pad body. The fluid channel includes an oblique channel segment extending from the central region to proximate the leading corner of the pad body, a lateral channel segment extending from proximate the leading corner of the pad body along the leading end of the pad body, and a longitudinal channel segment extending from proximate the leading corner of the pad body along the leading side of the pad body. The fluid channel defines through openings within the lateral channel segment and the longitudinal channel segment that are configured to direct the fluid from the input side to the output side of the pad body.

In an example of the applicator pad, the oblique channel segment, the lateral channel segment, and the longitudinal channel segment meet proximate the leading corner. In a further example of the applicator pad, the through holes within the longitudinal channel segment are configured to disburse fluid from the central region along the length of the cotton harvesting spindle during operation. In a further example of the applicator pad, the through holes within the lateral channel segment are configured to disburse fluid from the central region along the base of the cotton harvesting spindle during operation.

In a further example of the applicator pad, the longitudinal channel segment curves toward the central region as the longitudinal channel segment extends along the leading side of the pad body, and the lateral channel segment curves toward the central region as the lateral channel segment extends along the leading end of the pad body. In a further example of the applicator pad, a protrusion extends away from the output face, and wherein the protrusion is positioned and shaped to cover an area of the recess on the input face.

In a further example of the applicator pad, the applicator pad further includes a first protrusion position on the input face and running a perimeter of the pad body, the first protrusion extending away from the pad body to a distal end. The applicator pad further includes a second protrusion positioned at the distal end of the first protrusion and running an internal perimeter of the first protrusion, the second protrusion extending toward a central axis of the pad body.

In a further example of the applicator pad, an applicator pad coupler is configured to be positioned against the input face with the applicator pad coupler extending between the second protrusion and the input face. In a further example of the applicator pad, the applicator pad coupler covers the longitudinal channel segment allowing fluid to reach the longitudinal channel segment by traveling down the oblique channel segment. The applicator pad coupler is shaped to allow fluid to reach the lateral channel segment by traveling down the oblique channel segment or by overflowing the oblique channel segment to travel between the applicator pad coupler and the input face to reach the lateral channel segment.

In a further example of the applicator pad, each of the one or more contact features is attached to the output face at a proximal end and extends to a distal end away from the output face, each of the one or more contact features is tapered from the proximal end to the distal end, and each of the one or more contact features also extends along the direction of the leading end of the pad body.

In one implementation a spindle cleaning assembly for a cotton harvesting work vehicle is disclosed. A spindle holding bar passes through the spindle cleaning assembly to moisten and clean spindles attached to the spindle holding bar during operation of the cotton harvesting work vehicle. The spindle cleaning assembly includes a housing, a fluid inlet attached to the housing, and a fluid distributor attached to the housing and fluidically coupled to the fluid inlet. The spindle cleaning assembly further includes a plurality of tubes attached to outputs of the fluid distributor, and a plurality of applicator pad assemblies attached to and positioned along the housing. A tube of the plurality of tubes extends from the fluid distributor to each applicator pad assembly of the plurality of applicator pad assemblies. Each applicator pad assembly includes an applicator pad holder attached to the housing and extending away from the housing to a distal end, and an applicator pad attached to the distal end of the applicator pad holder. The applicator pad configured to clean and lubricate a spindle as it passes by the applicator pad, The applicator pad includes a pad body with a leading side and a leading end defining a leading corner at which the cotton harvesting spindle first encounters the pad body during operation. The pad body has an output face with one or more contact features projecting away from the output face and an input face opposite the output face. The input face having a recess defining a fluid channel of the pad body. The fluid channel configured to direct a fluid from a central region of the pad body to proximate the leading corner of the pad body. The fluid channel includes an oblique channel segment extending from the central region to proximate the leading corner of the pad body, a lateral channel segment extending from proximate the leading corner of the pad body along the leading end of the pad body, and a longitudinal channel segment extending from proximate the leading corner of the pad body along the leading side of the pad body. The fluid channel defines through openings within the lateral channel segment and the longitudinal channel segment that are configured to direct the fluid from the input side to the output side of the pad body. Each tube extending from the fluid distributor extends to the central region of the applicator pad, and wherein fluid from the fluid inlet is received at the central region of each applicator pad.

In an example of the spindle cleaning assembly, the oblique channel segment, the lateral channel segment, and the longitudinal channel segment meet proximate the leading corner. In a further example of the spindle cleaning assembly, the through holes within the longitudinal channel segment are configured to disburse fluid from the central region along the length of the cotton harvesting spindle during operation. In a further example of the spindle cleaning assembly, the through holes within the lateral channel segment are configured to disburse fluid from the central region along the base of the cotton harvesting spindle during operation.

In a further example of the spindle cleaning assembly, the longitudinal channel segment curves toward the central region as the longitudinal channel segment extends along the leading side of the pad body. The lateral channel segment curves toward the central region as the lateral channel segment extends along the leading end of the pad body. In a further example of the spindle cleaning assembly, a protrusion extends away from the output face, and the protrusion is positioned and shaped to cover an area of the recess on the input face.

In a further example of the spindle cleaning assembly, the applicator pad further includes a first protrusion position on the input face and running a perimeter of the pad body, the first protrusion extending away from the pad body to a distal end, and a second protrusion positioned at the distal end of the first protrusion and running an internal perimeter of the first protrusion, the second protrusion extending toward a central axis of the pad body.

In a further example of the spindle cleaning assembly, an applicator pad coupler is configured to be positioned against the input face with the applicator pad coupler extending between the second protrusion and the input face, and wherein the applicator pad coupler is attached to the distal end of the applicator pad holder. In a further example of the spindle cleaning assembly, the applicator pad coupler covers the longitudinal channel segment allowing fluid to reach the longitudinal channel segment by traveling down the oblique channel segment. The applicator pad coupler is shaped to allow fluid to reach the lateral channel segment by traveling down the oblique channel segment or by overflowing the oblique channel segment to travel between the applicator pad coupler and the input face to reach the lateral channel segment.

In a further example of the spindle cleaning assembly, each of the one or more contact features is attached to the output face at a proximal end and extends to a distal end away from the output face, each of the one or more contact features is tapered from the proximal end to the distal end, and each of the one or more contact features also extends along the direction of the leading end of the pad body.

### BRIEF DESCRIPTION OF THE DRAWINGS

FIG. 1 is a perspective view of an example cotton harvesting work vehicle in which the present disclosure may be incorporated;

FIG. 2 is a schematic diagram a harvesting unit of a cotton harvesting work vehicle being used to harvest cotton;

FIG. 3 is a perspective view of a spindle cleaning assembly for a cotton harvesting work vehicle with a row of spindles adjacent the spindle cleaning assembly;

FIG. 4 is a detailed cross-section view taken along cross-section line 4 -4 of FIG. 3;

FIG. 5 is a detailed view of area 5 of FIG. 4;

FIG. 6 is a perspective view of an applicator pad assembly with a cotton harvesting spindle adjacent the applicator pad assembly;

FIG. 7 is a cross-section view thereof taken along cross-section line 7 -7 of FIG. 6;

FIG. 8 is a side view of the applicator pad and spindle shown in FIG. 6;

FIG. 9 is a perspective view thereof;

FIG. 10 is a bottom view thereof; and

FIG. 11 is a cross-section view thereof taken along cross-section line 11 -11 of FIG. 10.

Throughout the drawings, identical reference numbers designate the same element. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Example embodiments of the present disclosure are shown in the accompanying figures of the drawings described briefly above. Various modifications to the example embodiments may be contemplated by one of skill in the art without departing from the scope of the present invention, as set forth in the appended claims.

### Overview

Cotton harvesting work vehicles include a cotton harvesting system and a moisture system. The cotton harvesting system includes spindles and doffers. The spindles rotate and separate the cotton from the plant and the doffers strip the cotton off the spindles. The cotton may then be guided to a suction duct to move the cotton to a storage basket on the cotton harvesting work vehicle. Debris from the cotton plants (e.g., cotton, cotton sap, and/or other plant debris) may remain on the spindles after the doffer removes the cotton. As such, the debris may stick to the spindles and eventually build up on the spindles. To reduce or prevent the build-up of debris, the spindles pass through a spindle cleaning assembly (e.g., a moisture column) of the moisture system to lubricate and clean the spindles and help prevent the debris from sticking to the spindles.

The spindle cleaning assembly may include applicator pads, where during operation of the harvesting system, each spindle may pass into contact with an applicator pad to remove and prevent the buildup of cotton debris. The applicator pad may have a plurality of fins extending from one side. Each spindle may move along an applicator pad with the fins scrubbing against the rotating spindle. The side of the applicator pad opposite the fins may receive a liquid with the liquid passing through apertures in the applicator pad to lubricate the spindle. Some applicator pads may have apertures arranged in an “x” shape with the liquid entering the applicator pad in at or near the center of the applicator pad. As such, the liquid primarily passes through the apertures at the center of the “x” shape with less passing through the apertures at the ends of the “x” shape. After prolonged use and with less liquid passing through the outer periphery of the applicator pad, there a buildup of cotton debris on the base or barrel of the spindles may occur. In addition to this buildup, the apertures towards the periphery of the applicator pad may become clogged with cotton debris from the spindles, exacerbating the effect and causing more debris buildup due to the spindle not being on properly lubricated and cleaned.

The present disclosure provides an applicator pad that directs the liquid to the spindle to better lubricate and clean the spindle. For example, the applicator pad may have a leading side and a leading end defining a leading corner at which the cotton harvesting spindle first encounters the pad body during operation. Each spindle may rotate as it passes proximate the applicator pad allowing the entire spindle to be scrubbed by the applicator pad. The applicator pad may have fins extending from one side of the applicator pad that contact the spindles. The applicator pad may receive liquid on the side opposite the fins and the liquid may pass through the applicator pad through holes. The applicator pad may be designed to have through holes run along the leading side to lubricate the entire length of the spindle and also have through holes run along of the leading end to lubricate the base of the spindle. For example, as the spindle brushes past the applicator pad, the base of the spindle may be positioned under the through holes that run in the direction of the leading end. As such, the through holes in the direction of the leading end allow the liquid received by the applicator pad to be directed toward the base of the spindle to lubricate the spindle and clean the spindle preventing the buildup of cotton debris at the base of the spindle. Without the buildup on the spindle, the through holes located towards the base of the spindle may not clog with debris from the cotton plants.

An applicator pad coupler positions the applicator pad against an applicator pad holder. The applicator pad holder positions the applicator pad in the appropriate position to physically contacts the spindles to lubricate and clean the spindles during operation of the cotton harvesting system. The applicator pad coupler may also direct more fluid received by the applicator pad toward the through holes that run along the leading end than toward the through holes that run along the leading side. For example, the through holes may be positioned within a fluid channel in the applicator pad and the applicator pad coupler may direct liquid to both a leading end channel segment and a leading side channel segment at the same time but may direct more liquid to the leading end channel segment through a secondary fluid path. A leading side channel segment may run generally along the leading side and the leading end channel segment may run along the leading end. The fluid channel may also have an oblique channel segment that directs the received liquid towards both the leading end channel segment and the leading side channel segment. The applicator pad coupler may be designed to direct any liquid overflow of the oblique channel segment to the leading end channel segment through a secondary fluid path and prevent the overflow from first reaching the leading side channel segment. As such, more liquid may be positioned on the spindle at the base of the spindle, while still allowing the entire spindle to be lubricated with liquid. This process may provide more liquid to the positions on the spindle where cotton debris is known to build up compared to other applicator pad designs. As such, the applicator pad may keep the spindles cleaner than previous applicator pads.

The applicator pad includes two sets of through holes. One set of through holes is positioned proximate the leading side and runs along the leading side more than the leading end. Another set of through holes is proximate the leading end and runs in along the leading end more than the leading side. The number of through holes needs to be enough to provide liquid through the applicator pad to the spindle to lubricate and clean the spindle. As such, the exact number of through holes may change based on the size of the applicator pad and size of the spindle. The through holes are positioned between the fins and the fins may help scrub the fluid passing through the applicator pad onto a spindle brushing past the applicator pad. The exact positions of the through holes does not matter as long as enough lubricant is placed on the spindles to prevent buildup of cotton debris. For example, the spindles may be tapered from the base toward the tip of the spindle. As such, more fluid may be needed at the base of the spindle than at the tip to properly lubricate and clean the spindle due to the base having a larger surface area than at the tip of the spindle. Therefore more through holes may be positioned proximate the base of the spindle to provide the more fluid needed.

The applicator pad may be any overall shape, for example, square, rectangular, diamond, circular, etc, allowing the fluid to be directed to the spindle to clean and lubricate the spindle. For example, fins may extend away from the applicator pad and fluid may pass through through holes positioned between some of the fins. The fins may help spread the fluid onto each spindle that passes proximate the applicator pad and scrub the spindle. The applicator pad may be shaped to allow the entire length of the spindle to be cleaned and lubricated by the applicator pad.

The fins connect to a pad body of the applicator pad at a proximal end and extend away to a distal end of the fin. The fins may taper from the proximal end towards the distal end. In an alternative, the fins may have the same thickness from the pad body to the distal end. Each fins may run the length of the applicator pad or there may be multiple fins to run the length of the applicator pad. Each fin may be any shape or length allowing them to physically contact the spindles. Fluid may exit through holes positioned between the fins and onto and around the rotating spindle.

The applicator pad may be positioned by an applicator pad holder. The applicator pad may be positioned against the applicator pad holder by an applicator pad coupler. The applicator pad coupler may attach to a distal end of the applicator pad holder and attach to the applicator pad. For example, the applicator pad coupler may insert under a lip of the applicator pad, where the lip holds the applicator pad against the applicator pad coupler. In an alternative, aspect, the applicator pad may screw or glue against the applicator pad coupler to attach the applicator pad coupler to the applicator pad. In any case, a liquid seal may be formed between the applicator pad and the applicator pad coupler when the applicator pad is attached to the applicator pad coupler. Additionally, the shape of the applicator pad coupler may help direct any fluid received by the applicator pad to the appropriate through holes to provide the fluid to any spindles passing proximate the applicator pad.

An example embodiment of an applicator pad is provided according to the present disclosure. The following description should be understood as merely providing one or more non-limiting examples context in which embodiments of the present disclosure may be better understood.

### Example Applicator Pad of a Cotton Harvesting Work Vehicle

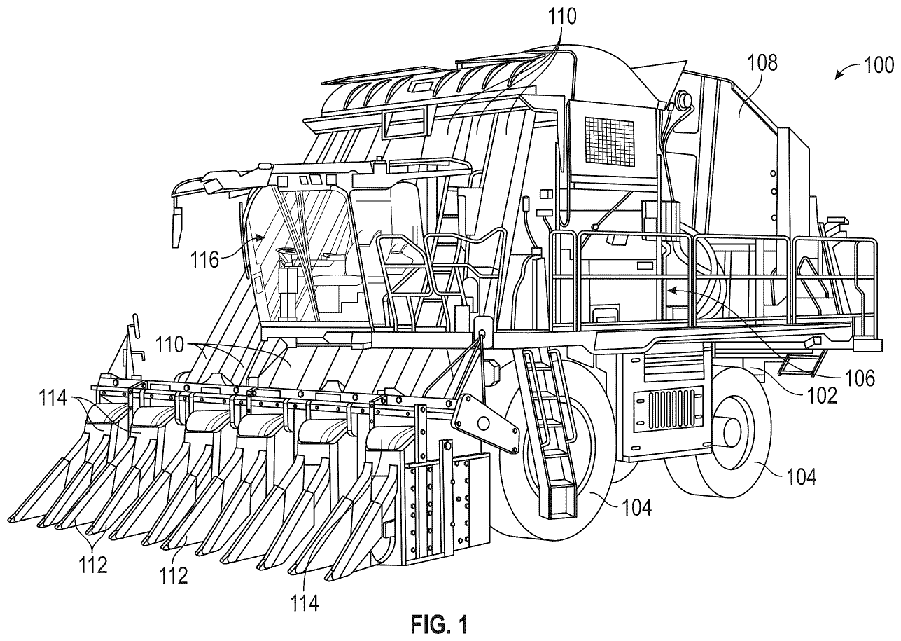

Referring to FIG. 1, a cotton harvesting work vehicle 100 is shown that can implement embodiments of the disclosure. In the illustrated example, the cotton harvesting work vehicle 100 is depicted as a cotton picker. The cotton harvesting work vehicle 100 includes a chassis 102 (i.e., frame) carried on front and rear wheels 104. Positioned in a middle region of the chassis 102 is an engine 106. The engine system provides power via an associated drivetrain to an output member (e.g., an output shaft, not shown) that, in turn, transmits power to axle(s) of the work vehicle 100 to provide propulsion thereto and additionally powers the other implements of the cotton harvesting work vehicle 100.

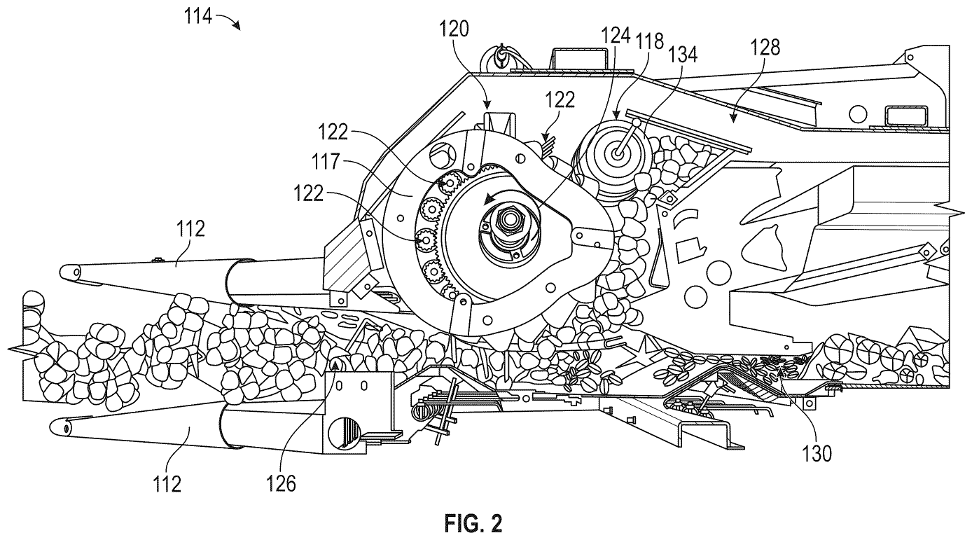

The cotton harvesting work vehicle 100 includes a basket 108, suction ducts 110, stalk lifters 112, and harvesting units 114. These implements may each be powered by the engine 106. Each harvesting unit 114 may have two stalk lifters 112 attached on an input 126 (FIG. 2) of the harvesting unit 114 and each harvesting unit 114 has a suction duct 110 connected to the output side of the harvesting unit 114. The suction ducts 110 extend from a harvesting unit 114 to the basket 108. As the cotton harvesting work vehicle 100 is operated, the stalk lifters 112 may lift and guide cotton stalks into the harvesting units 114. The harvesting units 114 strip the cotton off of the cotton stalks. The cotton stalks with the cotton removed travel through the cotton harvesting units 114 to be placed back on the ground. The harvested cotton may be suctioned through the suction ducts 110 and into the basket 108. The operator may operate the cotton harvesting work vehicle 100 to harvest cotton until the basket 108 full of cotton.

The cotton harvesting work vehicle 100 may include a controller to monitor parameters of the cotton harvesting work vehicle 100. For example, the cotton harvesting work vehicle 100 may include an operator cabin 116 including one or more display devices and any of various operator interfaces coupled to the controller. Apart from the display devices, the operator interface devices may include various video and audio devices for providing video and audio information, haptic devices that provide haptic feedback, levers, joysticks, steering wheels, pedals, buttons, and so on. Operator interface devices can also be a set of inputs displayed on the display devices, for example, links, icons, or other user actuatable mechanisms. Additionally, or alternatively, some portion of the operator interfaces may be integrated into the display devices, such that the operator interfaces may include physical inputs (e.g. buttons, switches, dials, etc.) on or near the display devices, a touchscreen module integrated into the display devices, or a cursor input device (e.g., a joystick, trackball, or mouse) for positioning a cursor utilized to interface with GUI elements generated on the display devices. The display devices can be any image-generating device configured for operation within the operator cabin, including one or more dedicated display consoles and various heads-up display projectors.

The display devices and operator interfaces are operatively coupled to the controller with various data connections between these components representative of wired and/or wireless data connections. The controller may have one or more controllers or other control architecture that can assume any form suitable for performing the functions described herein and is used in a non-limiting sense to generally refer to the processing architecture or system of the cotton harvesting work vehicle 100 or other computing device or group of devices. For example, the controller may encompass or may be corresponding to any practical number of processors, control computers, computer-readable memories, power supplies, storage devices, interface cards, and other standardized components, and may also include or cooperate with any number of firmware and software programs or computer-readable instructions designed to carry-out the various process tasks, calculations, and control/display functions described herein, all represented by a processor. Such computer-readable instructions may be stored within a non-volatile sector of a local onboard memory, which is accessible to the controller. While generically illustrated as a single block, the memory can encompass any number and type of storage media suitable for storing computer-readable code or instructions, as well as other data utilized to support the operation of the cotton harvesting work vehicle 100. The memory may be integrated into the controller architecture in various embodiments such as, for example, a system-in-package, a system-on-a-chip, or another type of microelectronic package or module.

The cotton harvesting work vehicle 100 may include a plurality of sensors coupled to the controller. The sensors may provide the controller with data regarding the different implements and/or engine of the cotton harvesting work vehicle 100. For example, the basket 108 may include a sensor to provide data indicative of the fullness the basket 108. Another example, is a sensor providing data indicative of how full a moisture tank is for the harvesting units 114. Another example, is a sensor providing data indicative of a jam occurring within a harvesting unit 114. There are various other sensors that may be on the cotton harvesting work vehicle 100. The controller monitors the signals or data received from the sensors and adjusts operation of the cotton harvesting work vehicle 100 based on the data. The controller may also provide the operator with information regarding the data. For example, providing the operator with information regarding how full the basket 108 is currently as well as other parameters of the cotton harvesting work vehicle 100.

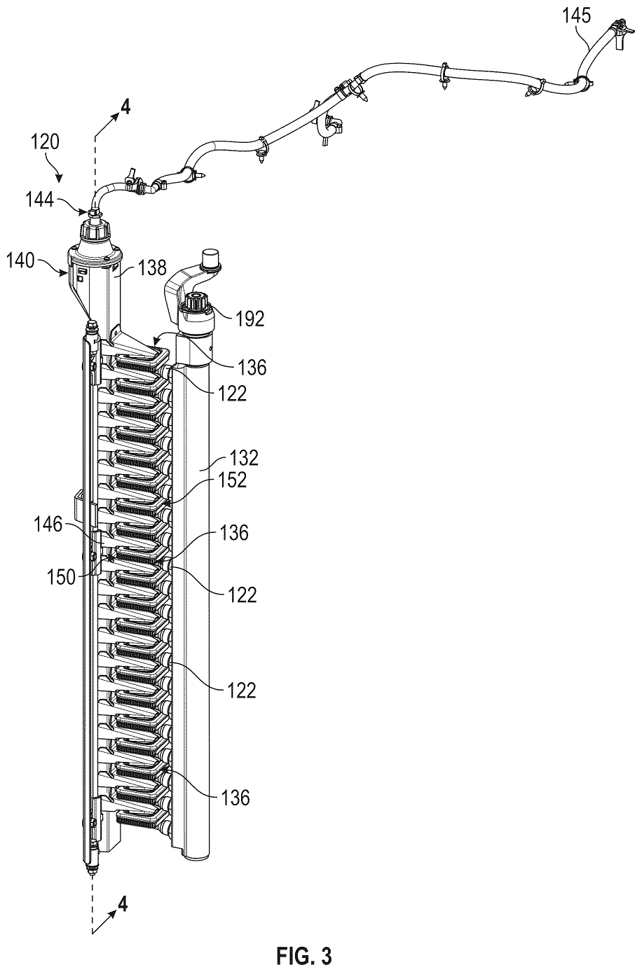

Referring to FIG. 2, each harvesting unit 114 may include a spindle drum 117, a doffer assembly 118, and a spindle cleaning assembly 120. The spindle drum 117 may include a plurality of spindle bars 132 and spindles 122 (FIG. 3) that rotate around the rotation axis 124. Each spindle bar 132 includes a plurality of spindles 122 attached along the spindle bar 132. Each spindle 122 attaches to the spindle bar 132 proximate a base 206 of the spindle and extends to a distal end 208 of the spindle 122. The spindle bar 132 may function as a spindle holding bar. Each harvesting unit 114 has an input 126, a cotton output 128, and a stalk output 130. The stalk lifters 112 may lift and guide cotton stalks into the input 126 of the harvesting unit 114. The cotton stalks may be guided to the spindle drum 117. The spindle bars 132 rotate around the rotation axis to move the spindles 122 into contact with the cotton stalks. Each spindle 122 rotates about itself to remove the cotton from the cotton stalk by twisting the cotton onto the spindle. Once the cotton is removed from the cotton stalk, the empty stalks are guided out the stalk output 130 and the stalks fall to or remain in the ground. The rotation of the spindle bar 132 moves the spindles 122 with cotton toward the doffer assembly 118. The doffer assembly 118 includes a plurality of doffers. In at least one aspect, each doffer may be a rubber disk. As the spindle bar 132 rotates past the doffer assembly 118, each spindle 122 may contact a doffer 134 and the doffer 134 may remove the harvested cotton from the spindle 122. For example, the doffers 134 may rotate faster than the spindle 122 and in an opposing direction to “unwind” the cotton from the spindle 122. The harvested cotton may then be guided out the cotton output 128 and into a suction duct 110 to be suctioned into the basket 108.

The spindle bar 132 and spindles 122 are then rotated around the rotation axis 124 toward the spindle cleaning assembly 120. The spindles 122 pass by and contact the spindle cleaning assembly 120, where the spindle cleaning assembly 120 cleans and lubricates each spindle 122 on the spindle bar 132. The cleaning and lubricating of the spindles 122 help to remove cotton debris and prevent buildup of cotton debris. After the spindle bar 132 and spindles 122 pass by the spindle cleaning assembly 120, the spindle bar 132 and spindles 122 continue to rotate around the rotation axis 124 on the spindle drum 117 to reach new cotton stalks that entered through the input 126. The spindles 122 harvest the cotton from these new stalks and the cycle of harvesting cotton and passing through the spindle cleaning assembly 120 continues as the spindle drum 117 rotates.

Referring to FIG. 3, the spindle cleaning assembly 120 includes a housing 138, a fluid distributor 140, a plurality of distributor tubes 142, a fluid inlet 144, and a plurality of applicator pad assemblies 136. In at least one aspect, the spindle cleaning assembly 120 may be considered a moistener column. The plurality of applicator pad assemblies 136 are attached and distributed along the housing 138. The distribution of the applicator pad assemblies 136 matches the distribution of spindles 122 along the spindle bar 132. The spindle bar 132 includes an input gear 192 that rotates internal gearing 194 that causes each spindle 122 to rotate about themselves. For example, a rotation gear 196 of the spindle 122 is meshed with the internal gearing 194 causing the spindle 122 to rotate when the input gear 192 rotates. In at least one aspect, the rotation of the spindle bar 132 about the rotation axis 124 may cause the input gear 192 to rotate.

Each applicator pad assembly 136 may include an applicator pad holder 146, applicator pad coupler 148, and an applicator pad 150. Each applicator pad holder 146 attaches to the housing 138 and extends away from the housing 138 to a distal end 152 of the applicator pad holder 146. The applicator pad 150 is attached to the distal end 152. The applicator pad coupler 148 may couple the applicator pad 150 to the distal end 152. For example, the applicator pad coupler 148 may attach to both the distal end 152 and the applicator pad 150 to position the applicator pad 150 proximate the distal end 152.

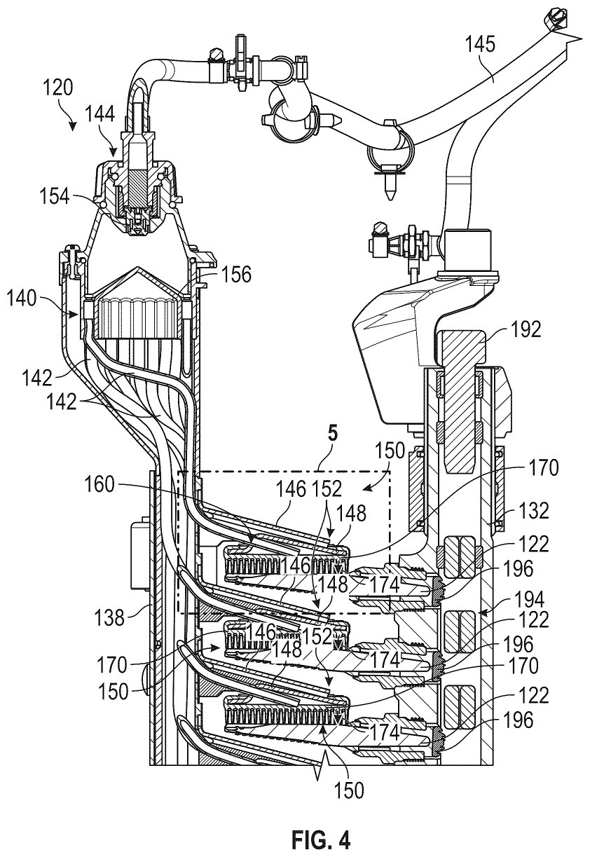

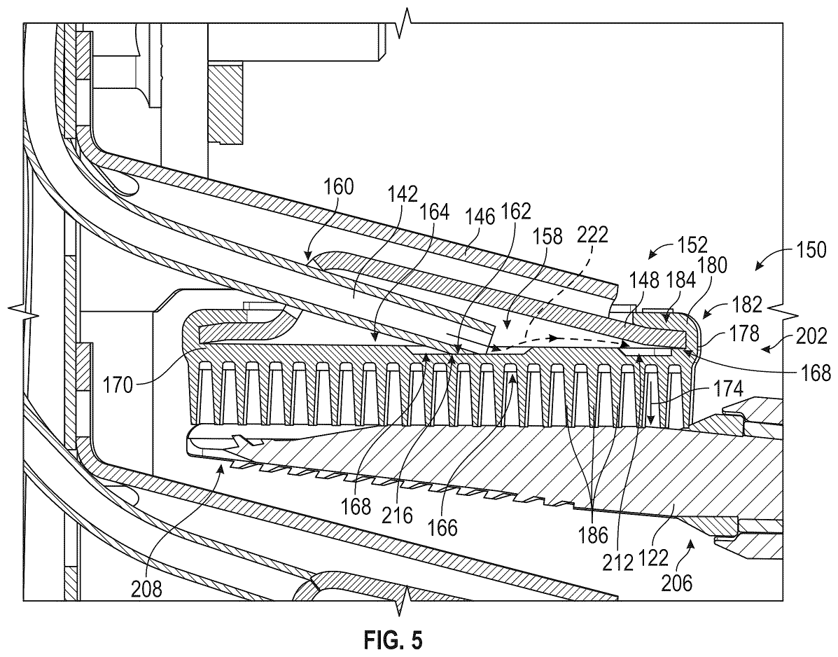

Referring to FIG. 4, the pressurized fluid enters the fluid inlet 144 at the top of the housing 138. The fluid inlet 144 is fluidically coupled to the fluid distributor 140. As such, fluid passes through the fluid inlet 144 to reach the fluid distributor 140. For example, pressurized fluid may pass into the fluid inlet 144 and exit through a nozzle 154. The nozzle 154 may spray a hollow cone of fluid onto an impingement plate 156 within the fluid distributor 140. The impingement plate 156 may have a tapered conical surface. In at least one aspect, the fluid that passes through the nozzle 154 is no longer under pressure. The fluid then may pass down the impingement plate 156 to reach one of the plurality of fluid outputs of the fluid distributor 140, where each output is connected to one of the plurality of distributor tubes 142. The distributor tubes 142 may extend from the fluid distributor 140 to an applicator pad assembly 136 to fluidically couple the fluid distributor 140 to an applicator pad 150. The distributor tubes 142 are housed within the housing 138 and exit the housing 138 to inside of an applicator pad holder 146. The tube 142 extends down the applicator pad holder 146 to reach the applicator pad coupler 148 and applicator pad 150. The tube 142 extends through a hole 160 (FIG. 5) within the applicator pad coupler 148 to reach the applicator pad 150. The fluid exiting the fluid distributor 140 may travel through the distributor tubes 142 to reach an applicator pad 150. In at least one aspect, the fluid is gravity fed through the distributor tubes 142.

Referring to FIG. 5, the tube 142 may be inserted through a hole 160 in the applicator pad coupler 148. The fluid may travel down the tube 142 to reach the applicator pad 150. The applicator pad 150 includes a pad body 170 having an input face 164 and an output face 166. The applicator pad coupler 148 rests against the input face 164. A chamber 158 is formed between the applicator pad 150 and the applicator pad coupler 148. The attachment between the applicator pad coupler 148 and applicator pad 150 may form a liquid seal.

The fluid for each spindle cleaning assembly 120 positioned within the harvesting units 114 may come from a fluid tank (not shown). The fluid inlet 144 may be coupled to the fluid tank by a tube 145. A pump (not shown) may pump fluid from the fluid tank down the tube 145 to reach each spindle cleaning assembly 120. The fluid may be pumped down the tube 145 at a pressure above a pressure threshold value. The pressure threshold value may be determined based on the number of spindle cleaning assemblies 120 being supplied fluid by the pump. The controller may control the pump to send liquid down the tube 145 to each spindle cleaning assembly 120 when the harvesting units 114 are operating. The control may then turn off the pump when the harvesting units 114 are not operating. This allows the fluid to only be sent to the applicator pads 150 of each spindle cleaning assembly 120 when the spindles 122 may rotating around the rotation axis 124 and as such passing the applicator pads 150.

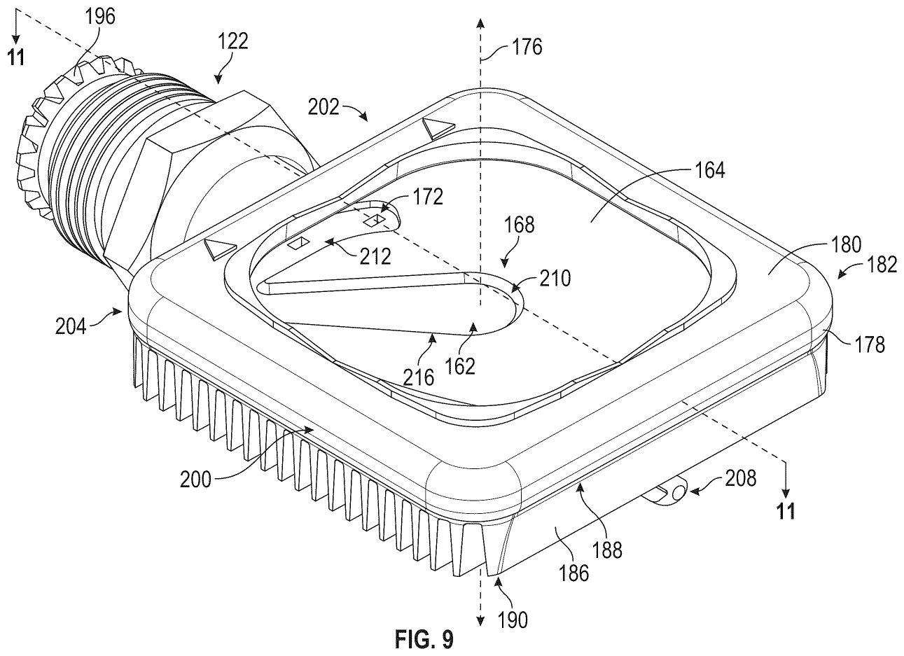

The input face 164 includes a recess 216 that defines a fluid channel 168. The fluid travels down the tube 142 to enter the chamber 158 and exits the tube 142 at a central region 162 of the pad body 170. The fluid may then travel along the fluid channel 168 and exit the fluid channel 168 by way of through holes 172 (FIGS. 9-11) in the pad body 170. The through holes 172 being positioned within the fluid channel 168. Arrow 174 indicates fluid passing through the through holes 172 to reach a cotton harvesting spindle 122 moving past the applicator pad 150.

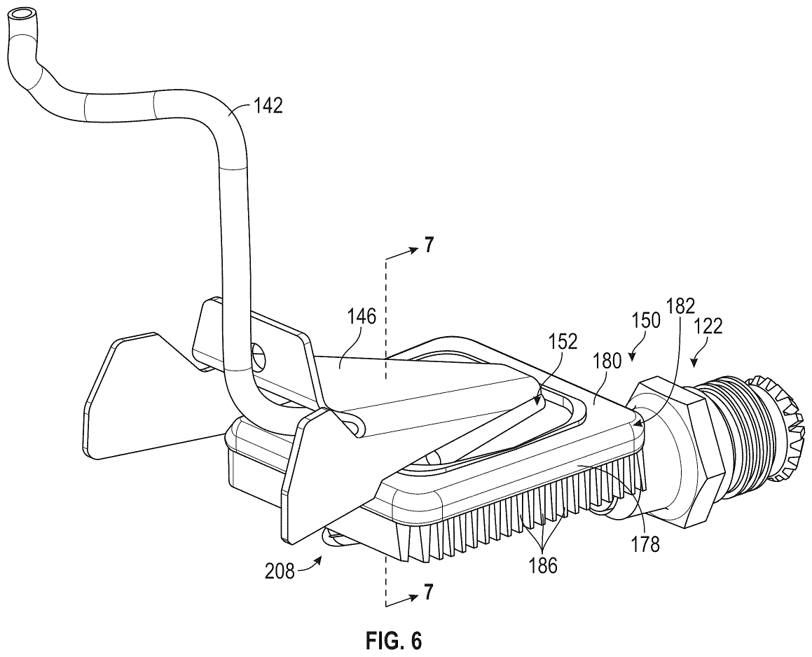

Referring also to FIGS. 5-11, a first protrusion 178 may extend away from the input face 164 of the pad body 170. The first protrusion 178 runs along the perimeter of the pad body 170 and the first protrusion 178 extends away from the pad body 170 along the central axis 176 (FIG. 9) to a distal end 182. A second protrusion 180 may extend away from the distal end 182 and toward the central axis 176. The second protrusion 180 may run along the internal perimeter of the first protrusion 178. The distal end 182 may be rounded. The first protrusion 178 and the second protrusion 180 may for a lip 184. The applicator pad coupler 148 may extend below the lip 184 of the applicator pad 150. For example, the applicator pad coupler 148 may be positioned against the input face 164 with the applicator pad coupler 148 extending between the second protrusion 180 and the input face 164.

The applicator pad 150 may be made of a material (e.g., a polyurethane material) that allows the lip 184 to flex to allow the applicator pad coupler 148 to be positioned under the lip 184. A tight fit between the lip 184 and the applicator pad coupler 148 may form the liquid seal and hold the applicator pad 150 in positioned against the applicator pad coupler 148. The applicator pad coupler 148 may be attached to the distal end 152 of the applicator pad holder 146. For example, the applicator pad coupler 148 may be riveted or bolted to the distal end 152 of the applicator pad holder 146. In any case, the tight fit between the applicator pad coupler 148 and the applicator pad 150 may hold and position the applicator pad 150 relative to the distal end 152 of the applicator pad holder 146. In an alternative, the applicator pad 150 may be attached to the applicator pad coupler 148 by bolting or some other such manner.

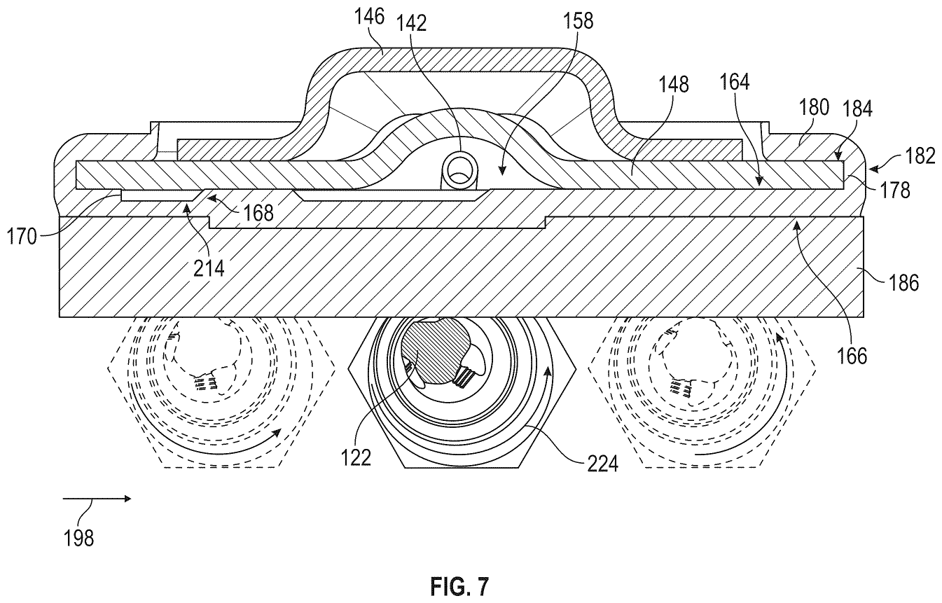

The applicator pad holder 146 may position the applicator pad 150 so that the cotton harvesting spindles 122 may pass by and contact the applicator pad 150 as the spindle bars 132 and spindles 122 rotate about the rotation axis 124 as discussed regarding FIG. 2. Referring to FIGS. 7, 10, and 11, the spindles 122 may move in an arc path 198 across the applicator pad 150 and brush against the contact features 186. The spindles 122 may move in the arc path 198 due to the spindles 122 rotating about the rotation axis 124. The spindles 122 may also rotate about themselves as they move past the applicator pad 150 as shown by rotation arrow 224 and the phantom spindles 122 viewable in FIG. 7.

The pad body 170 of the applicator pad 150 includes a leading side 200 and a leading end 202 that may meet together to define a leading corner 204. The cotton harvesting spindle 122 first encounters the leading corner 204 as it moves past the applicator pad 150. The leading side 200 extends to cover the length of the cotton harvesting spindle 122 as the cotton harvesting spindle 122 arc across the applicator pad 150. The longitudinal length of the spindle 122 may be from the base 206 to the distal end 208 of the spindle 122. The leading end 202 extends away from the leading side 200. The leading end 202 may be proximate the base 206 of the cotton harvesting spindle 122 as the spindle 122 moves across the applicator pad 150.

Referring also to FIGS. 5-11, the applicator pad 150 includes one or more contact features 186 projecting away from the output face 166. The one or more contact features 186 may contact the spindle 122 as the spindle 122 moves past the applicator pad 150. The contact features 186 may be flexible and would not break due to contact with the spindle 122. The contact between the applicator pad 150 and the one or more contact features 186 may help to remove any buildup of debris from the cotton plants. The one or more contact features 186 may also help spread the fluid sprayed through the through holes 172 onto the spindle 122 surface. The one or more contact features 186 connect to the pad body 170 at a proximal end 188 and extend to a distal end 190 away from the output face 166. Each of the one or more contact features 186 may tapered from the proximal end 188 to the distal end 190. The one or more contact features 186 may extend across the applicator pad 150 along the direction of the leading end 202 of the applicator pad 150. In at least one aspect, the one or more contact features 186 may be fins positioned across the output face 166. The one or more contact features 186 may be spaced and positioned along the entire output face 166.

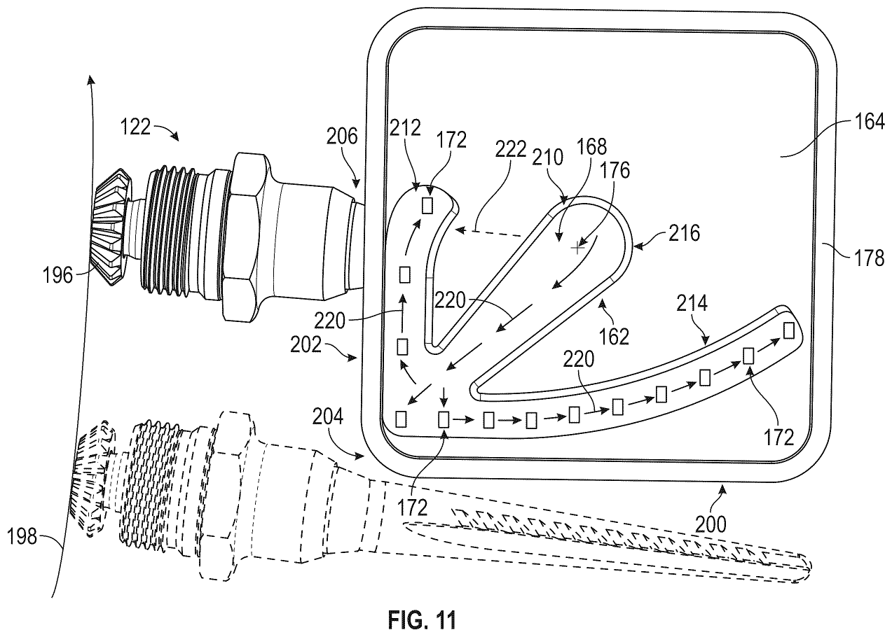

As discussed above, the input face 164 includes the recess 216 that defines the fluid channel 168, best viewed in FIG. 11. The fluid channel 168 includes an oblique channel segment 210, a lateral channel segment 212, and a longitudinal channel segment 214. The oblique channel segment 210 may extend from the central region 162 to proximate the leading corner 204 of the pad body 170. The central region 162 may be positioned at or proximate the center of the pad body 170.

The lateral channel segment 212 may connect with the oblique channel segment 210 proximate the leading corner 204. The lateral channel segment 212 may extend from proximate the leading corner 204 along the leading end 202 of the pad body 170. The lateral channel segment 212 may curve towards the central region 162 and the central axis 176 as the lateral channel segment 212 extends along the leading end 202. The lateral channel segment 212 may be proximate the base 206 of the cotton harvesting spindle 122 as the spindle 122 moves by the applicator pad 150. For example, the spindle 122 may extend across the leading end 202 with the base 206 being proximate the leading end 202 as the spindle 122 moves by the applicator pad 150.

The longitudinal channel segment 214 may connect with the oblique channel segment 210 and the lateral channel segment 212 proximate the leading corner 204. As such, the oblique channel segment 210, the lateral channel segment 212, and the longitudinal channel segment 214 may meet and connect proximate the leading corner 204. The longitudinal channel segment 214 may extend from proximate the leading corner 204 along the leading side 200 of the pad body 170. The longitudinal channel segment 214 may curve towards the central region 162 and the central axis 176 as the longitudinal channel segment 214 extends along the leading side 200. The longitudinal channel segment 214 may extend to cover the longitudinal length of the cotton harvesting spindle 122 from the base 206 to the distal end 208. For example, the spindle 122 may pass by the leading side 200 with the base 206 being proximate the leading corner 204 and the distal end 208 being proximate the end of the longitudinal channel segment 214 as the spindle 122 moves by the applicator pad 150.

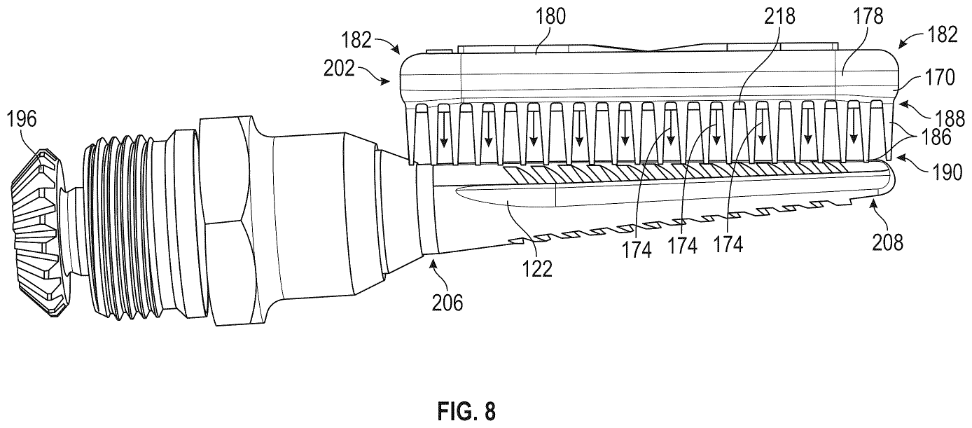

Referring also to FIG. 11, the fluid channel may define through holes 172 within the lateral channel segment 212 and the longitudinal channel segment 214 that are configured to direct the fluid from the input face 164 to the output face 166 of the pad body 170. The fluid exits the through holes 172 to reach the cotton harvesting spindle 122. The through holes 172 within the longitudinal channel segment 214 disburse fluid from the central region 162 along the longitudinal length of the cotton harvesting spindle 122 from the base 206 to the distal end 208 as the spindle 122 moves past the applicator pad 150. Referring to FIG. 8, the arrows 174 indicate the fluid exiting the through holes 172 in the longitudinal channel segment 214 to disperse fluid along the length of the cotton harvesting spindle 122 passing by the applicator pad 150. The through holes 172 within the lateral channel segment 212 disburse fluid from the central region 162 to the base 206 of the cotton harvesting spindle 122 as the spindle 122 moves past the applicator pad 150. Referring to FIG. 5, the arrow 174 indicates the fluid exiting the through holes 172 in the lateral channel segment 212 to disperse fluid at the base 206 of the cotton harvesting spindle 122 as the cotton harvesting spindle 122 moves by the applicator pad 150.

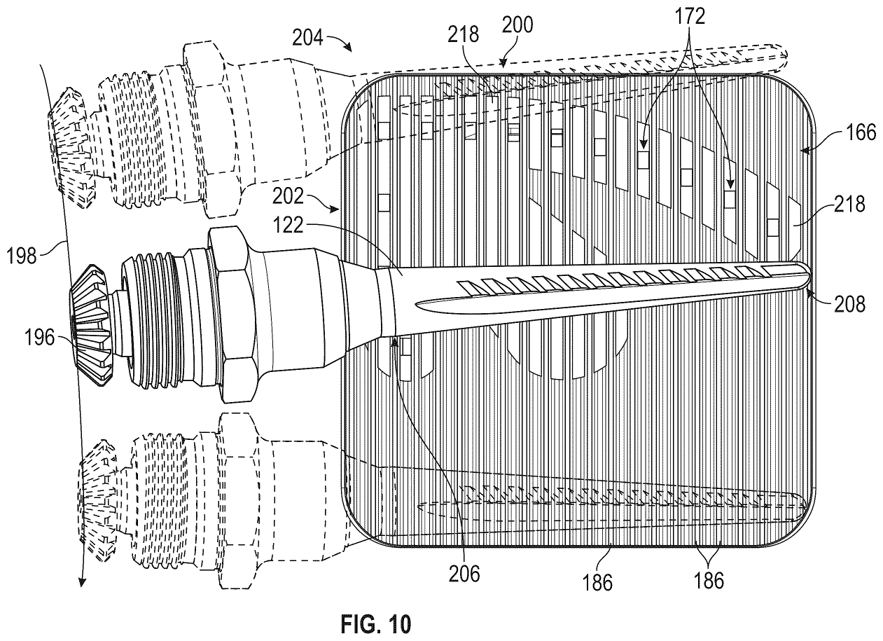

Referring to FIG. 10, the cotton harvesting spindle 122 may be tapered from the base 206 toward the distal end 208. As such, the base 206 may have a larger surface area than the distal end 208. Therefore more fluid may be needed to be dispersed at the base 206 than elsewhere along the length of the spindle 122. Referring also to FIG. 11, the through holes 172 positioned within the lateral channel segment 212 may provide this more liquid to the base 206 area.

There may be no through holes in the oblique channel segment 210. The oblique channel segment 210 guides fluid that exits the tube 142 at the central region 162 toward the through holes 172 position within the lateral channel segment 212 and longitudinal channel segment 214. Referring to FIG. 11, the fluid exits the tube 142 in the central region 162 and follows the main fluid path arrows 220 down the oblique channel segment 210 to proximate the leading corner 204. The fluid then splits continuing to follow the arrows 220 with some fluid going down the lateral channel segment 212 and some fluid going down the longitudinal channel segment 214 where all the fluid exits out one of the through holes 172 to pass from the input face 164 to the output face 166 of the pad body 170. When a spindle 122 passes under the through holes 172 during operation, the fluid is dispersed onto the spindle 122.

Referring to FIGS. 5, 7, and 11, there is a secondary fluid path that the fluid entering at the central region 162 may take if the oblique channel segment 210 is overflowed with fluid. For example, if enough fluid exits the tube 142 that the oblique channel segment 210 is overflowed, then the fluid that overflowed the oblique channel segment 210 may travel across the input face 164 to reach the lateral channel segment 212 as shown by the secondary fluid path arrows 222 shown in FIGS. 5 and 11. The applicator pad coupler 148 may be shaped to guide the overflowed fluid to the lateral channel segment 212. Referring to FIGS. 5 and 7, applicator pad coupler 148 is shaped to form the chamber 158 between the applicator pad coupler 148 and input face 164. The chamber 158 extends over at least part of the oblique channel segment 210 and the lateral channel segment 212, which would allow the overflowing fluid to travel across the input face 164 between the input face 164 and applicator pad coupler 148 to reach the lateral channel segment 212 and exit through the through holes 172. This secondary fluid path may provide more fluid to the lateral channel segment 212 to maximize the amount of fluid exiting the through holes 172 within the lateral channel segment 212 to properly coat the base 206 of a spindle 122 passing by the lateral channel segment 212. Maximizing the amount of fluid exiting the through holes 172 positioned with the lateral channel segment 212 may also help prevent any plugging of the through holes 172 due to debris from the cotton plants. Excess fluid within the lateral channel segment 212 due to fluid overflowing the oblique channel segment 210 may travel along the lateral channel segment 212 to reach the longitudinal channel segment 214. In some alternative aspects, the tube 142 may be positioned to allow fluid to exit the tube 142 into the oblique channel segment 210 and onto the input face 164 outside the oblique channel segment 210 simultaneously, the fluid then traveling to the lateral channel segment 212 and longitudinal channel segment 214 as described above.

Referring to FIG. 7, the applicator pad coupler 148 covers the longitudinal channel segment 214 to help prevent any overflowing fluid from entering the longitudinal channel segment 214 before entering the lateral channel segment 212. The applicator pad coupler 148 covering the longitudinal channel segment 214 also helps guide that overflowing fluid toward the lateral channel segment 212 as discussed above. Even with the longitudinal channel segment 214 covered by the applicator pad coupler 148, the fluid may still travel down the longitudinal channel segment 214 from proximate the leading corner 204. For example, the fluid may reach proximate the leading corner by flowing down the oblique channel segment 210 or by flowing down the lateral channel segment 212. If the oblique channel segment 210 is overflowing with fluid, there is still fluid flowing down the main fluid path arrows 220 traveling down the oblique channel segment 210 to reach the lateral channel segment 212 and longitudinal channel segment 214 to exit through the through holes 172.

The fluid exits the through holes 172 to disperse the fluid onto a spindle 122 that passes and brushes against the contact features 186. Engaging the contact features 186 while the fluid is spread onto the spindle 122 helps remove cotton debris buildup on the spindle 122. Referring to FIG. 10, the through holes 172 with the lateral channel segment 212 and longitudinal channel segment 214 are positioned between the one or more contact features 186. This positioning allows the fluid to disperse to reach a passing spindle 122 without affecting the one or more contact features 186.

Referring to FIGS. 8 and 10, a protrusion 218 extends away from the output face 166. The protrusion 218 is positioned and shaped to be the same as or larger than the area covered by the recess 216 of the input face 164. As such, the protrusion 218 may be to help maintain the strength of the pad body 170 at the position of the recess 216. For example, the pad body 170 thickness at the recess 216 may be increased by the thickness of the protrusion 218. This additional thickness may help the pad body 170 maintain its shape and prevent wear through at the location of the recess 216.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure. Although portions of the disclosure may use the phrase “at least one” or “one or more” of a particular component or element, unless otherwise specifically limited, the mere recitation of a single element or component does not preclude a plurality of such elements or components.

What is claimed is:

1. An applicator pad for a cotton harvesting spindle, the applicator pad comprising a pad body with a leading side and a leading end defining a leading corner at which the cotton harvesting spindle first encounters the pad body during operation, the pad body having an output face with one or more contact features projecting away from the output face and an input face opposite the output face, the input face having a recess defining a fluid channel of the pad body, the fluid channel configured to direct a fluid from a central region of the pad body to proximate the leading corner of the pad body, the fluid channel comprising:
an oblique channel segment extending from the central region to proximate the leading corner of the pad body;
a lateral channel segment extending from proximate the leading corner of the pad body along the leading end of the pad body; and
a longitudinal channel segment extending from proximate the leading corner of the pad body along the leading side of the pad body,
wherein the fluid channel defines through holes within the lateral channel segment and the longitudinal channel segment that are configured to direct the fluid from the input face to the output face of the pad body.

2. The applicator pad of claim 1, wherein the oblique channel segment, the lateral channel segment, and the longitudinal channel segment meet proximate the leading corner.

3. The applicator pad of claim 1, wherein the through holes within the longitudinal channel segment are configured to disburse fluid from the central region along a length of the cotton harvesting spindle during operation.

4. The applicator pad of claim 1, wherein the through holes within the lateral channel segment are configured to disburse fluid from the central region along a base of the cotton harvesting spindle during operation.

5. The applicator pad of claim 1, wherein the longitudinal channel segment curves toward the central region as the longitudinal channel segment extends along the leading side of the pad body, and wherein the lateral channel segment curves toward the central region as the lateral channel segment extends along the leading end of the pad body.

6. The applicator pad of claim 1, wherein a protrusion extends away from the output face, and wherein the protrusion is positioned and shaped to cover an area of the recess on the input face.

7. The applicator pad of claim 1, further comprising:
a first protrusion position on the input face and running a perimeter of the pad body, the first protrusion extending away from the pad body to a distal end; and
a second protrusion positioned at the distal end of the first protrusion and running an internal perimeter of the first protrusion, the second protrusion extending toward a central axis of the pad body.

8. The applicator pad of claim 7, wherein an applicator pad coupler is configured to be positioned against the input face with the applicator pad coupler extending between the second protrusion and the input face.

9. The applicator pad of claim 8, wherein the applicator pad coupler covers the longitudinal channel segment allowing fluid to reach the longitudinal channel segment by traveling down the oblique channel segment, and wherein the applicator pad coupler is shaped to allow fluid to reach the lateral channel segment by traveling down the oblique channel segment or by overflowing the oblique channel segment to travel between the applicator pad coupler and the input face to reach the lateral channel segment.

10. The applicator pad of claim 1, wherein each of the one or more contact features is attached to the output face at a proximal end and extends to a distal end away from the output face, wherein each of the one or more contact features is tapered from the proximal end to the distal end, and wherein each of the one or more contact features also extends along a direction of the leading end of the pad body.

11. A spindle cleaning assembly for a cotton harvesting work vehicle, wherein a spindle holding bar passes through the spindle cleaning assembly to moisten and clean spindles attached to the spindle holding bar during operation of the cotton harvesting work vehicle, the spindle cleaning assembly comprising:
a housing;
a fluid inlet attached to the housing;
a fluid distributor attached to the housing and fluidically coupled to the fluid inlet;
a plurality of tubes attached to outputs of the fluid distributor;
a plurality of applicator pad assemblies attached to and positioned along the housing, wherein a tube of the plurality of tubes extends from the fluid distributor to each applicator pad assembly of the plurality of applicator pad assemblies, wherein each applicator pad assembly comprises:
an applicator pad holder attached to the housing and extending away from the housing to a distal end; and
an applicator pad attached to the distal end of the applicator pad holder, the applicator pad configured to clean and lubricate a spindle as it passes by the applicator pad, and the applicator pad comprising a pad body with a leading side and a leading end defining a leading corner at which a cotton harvesting spindle first encounters the pad body during operation, the pad body having an output face with one or more contact features projecting away from the output face and an input face opposite the output face, the input face having a recess defining a fluid channel of the pad body, the fluid channel configured to direct a fluid from a central region of the pad body to proximate the leading corner of the pad body, the fluid channel comprising:
an oblique channel segment extending from the central region to proximate the leading corner of the pad body;
a lateral channel segment extending from proximate the leading corner of the pad body along the leading end of the pad body; and
a longitudinal channel segment extending from proximate the leading corner of the pad body along the leading side of the pad body,
wherein the fluid channel defines through holes within the lateral channel segment and the longitudinal channel segment that are configured to direct the fluid from the input face to the output face of the pad body, and
wherein each tube extending from the fluid distributor extends to the central region of the applicator pad, and wherein fluid from the fluid inlet is received at the central region of each applicator pad.

12. The spindle cleaning assembly of claim 11, wherein the oblique channel segment, the lateral channel segment, and the longitudinal channel segment meet proximate the leading corner.

13. The spindle cleaning assembly of claim 11, wherein the through holes within the longitudinal channel segment are configured to disburse fluid from the central region along a length of the cotton harvesting spindle during operation.

14. The spindle cleaning assembly of claim 11, wherein the through holes within the lateral channel segment are configured to disburse fluid from the central region along a base of the cotton harvesting spindle during operation.

15. The spindle cleaning assembly of claim 11, wherein the longitudinal channel segment curves toward the central region as the longitudinal channel segment extends along the leading side of the pad body, and wherein the lateral channel segment curves toward the central region as the lateral channel segment extends along the leading end of the pad body.

16. The spindle cleaning assembly of claim 11, wherein a protrusion extends away from the output face, and wherein the protrusion is positioned and shaped to cover an area of the recess on the input face.

17. The spindle cleaning assembly of claim 11, further comprising:
a first protrusion position on the input face and running a perimeter of the pad body, the first protrusion extending away from the pad body to a distal end; and
a second protrusion positioned at the distal end of the first protrusion and running an internal perimeter of the first protrusion, the second protrusion extending toward a central axis of the pad body.

18. The spindle cleaning assembly of claim 17, wherein an applicator pad coupler is configured to be positioned against the input face with the applicator pad coupler extending between the second protrusion and the input face, and wherein the applicator pad coupler is attached to the distal end of the applicator pad holder.

19. The spindle cleaning assembly of claim 18, wherein the applicator pad coupler covers the longitudinal channel segment allowing fluid to reach the longitudinal channel segment by traveling down the oblique channel segment, and wherein the applicator pad coupler is shaped to allow fluid to reach the lateral channel segment by traveling down the oblique channel segment or by overflowing the oblique channel segment to travel between the applicator pad coupler and the input face to reach the lateral channel segment.

20. The spindle cleaning assembly of claim 11, wherein each of the one or more contact features is attached to the output face at a proximal end and extends to a distal end away from the output face, wherein each of the one or more contact features is tapered from the proximal end to the distal end, and wherein each of the one or more contact features also extends along a direction of the leading end of the pad body.
